(19) United States
(12) Patent Application Publication
(10) Pub. No.: US 2002/0072456 A1
(43) Pub. Date: Jun. 13, 2002

(54) Method for exchanging metal mold of punch press and punch press with the exchanging method

(75) Inventor: Michiharu Ichikawa, Aichi (JP)

Correspondence Address: PEARNE & GORDON LLP, 526 SUPERIOR AVENUE EAST, SUITE 1200, CLEVELAND, OH, 44114-1484, US

(73) Assignee: Nissinbo Industries,Inc.

(21) Appl. No.: 10/016,409

(22) Filed: Dec. 10, 2001

(30) Foreign Application Priority Data
Dec. 11, 2000 (JP) P.2000-376493

(51) Int. Cl. B23Q 3/155; B23B 29/32; B26F 1/04

(52) U.S. Cl. 483/1; 483/28

(57) ABSTRACT

A punch press includes an upper metal mold mounting board 2 mounting the upper metal molds 16 and a lower metal mold mounting board 3 mounting the lower metal molds 17. A notch portion 20 or bore for exchange of a lower metal mold is provided in the upper metal mold mounting board 2. When the lower metal mold 17 is mounted or dismounted, the notch portion 20 or bore provided in the upper metal mold mounting board 2 is positioned above the lower metal mold 17 to be exchanged or its mounting hole, thereby mounting or dismounting the lower metal mold 17 through the notch portion 20 or bore.

### BACKGROUND OF THE INVENTION

1. Field of the Invention

The present invention relates to a metal mold exchanging (mounting or dismounting) method for making easily and rapidly the exchange of a lower metal mold (also called a die), particularly in a turret punch press, and a punch press with a structure for effecting the method.

2. Description of the Related Art

For example, in a turret punch press having a turret serving as a metal mold mounting board that is almost circular as seen in the plane, multiple pairs of upper metal molds (also called punch metal molds) and lower metal molds are provided on the upper and lower turrets, respectively. The turret punch press can perform the working such as punching on the continuous basis, employing multiple pairs of upper and lower metal molds for one workpiece, and is often used for metal sheeting in various fields.

FIG. 6 is a side view showing the essence of a drive system for the upper and lower turrets in a turret punch press. FIG. 7 is a side cross-sectional view for explaining a situation of mounting or dismounting (exchanging) a lower metal mold on a lower turret of FIG. 6.

The basic constitution of the conventional turret punch press and an operation of mounting or dismounting the lower metal mold will be specifically described below. In FIGS. 6 and 7, reference numeral 1 denotes a C-type frame in the well known turret punch press, and reference numerals 2 and 3 denote the circular upper and lower turrets supported rotatably by bearing portions 4 and 5 above and below an opening portion in the frame, respectively. Both the turrets 2 and 3 are opposed over an entire face with a gap G capable of inserting a plate-like workpiece (not shown).

The rotational shafts 6 and 7 for the upper and lower turrets 2 and 3 are provided with the input chain pulleys 8 and 9, respectively. Both the input chain pulleys 8 and 9 have the chains 14 and 15 for transmitting the rotation of the output chain pulleys 12 and 13 provided at the top and bottom of a shared output shaft 11 parallel to the shafts 6 and 7 and linked to a common drive motor 10, the chains 14 and 15 being looped around the output chain pulleys 8-12 and 9-13, respectively.

In the conventional turret punch press, the upper turret 2 and the lower turret 3 have a plurality of pairs of upper metal molds 16 and lower metal molds 17 arranged on the circumference, each of the metal molds 16 and 17 being mounted or dismounted freely. The upper metal molds 16 can be mounted or dismounted from the upper face side that is opened on the upper turret 2. However, the lower metal molds 17 that are arranged with a gap G from the bottom face of the upper turret 2 cannot be mounted or dismounted easily and rapidly in practice.

In FIG. 7, a lower metal mold 17 is carried detachably on the top face of the lower turret 3 by a holder base 17a and a die holder 17b , the die holder 17b being detachably provided on the holder base 17a secured to the lower turret 3. For mounting or dismounting the lower metal mold 17, the die holder 17b fixed detachably to the holder base 17a by a clamper 17c is removed outside the lower turret 3 after disengaging the clamper 17c . And the lower metal mold 17 is mounted or dismounted and another lower metal mold 17 is mounted, the die holder 17b is positioned on the holder base 17a , and secured by the clamper 17c , whereby the exchange or mounting or dismounting of the lower metal mold 17 is completed.

That is, the exchange or mounting or dismounting of the lower metal mold 17 can be only performed after removing the die holder 17b from the holder base 17a , namely, outside the lower turret 3. However, there is a problem with the operation form of dismounting or exchanging the lower metal mold 17 in respect of the rationalization and expedition of operation. Also, the lower metal mold 17 is mounted after a two-layer structure of the holder base 17a and the die holder 17b provided on the holder base 17a is secured by means of the clamper 17c , resulting in poor assembling precision.

In the turret punch press, a greater number of metal molds are provided on the turret to reduce the number of arrangements to change the used metal mold. Also, the upper and lower molds carrying the workpiece between them are disposed in adjacently confronted state. Therefore, in particular, an operation for mounting or dismounting the lower metal mold in or from a metal mold hole of the lower turret must be performed in a small space (gap between the upper and lower turrets) . Practically, it is impossible to mount or dismount the lower metal mold by a hand or tool that is inserted into the small space.

In the conventional art, in order to solve this problem, a lower metal mold mounting portion in the lower turret is made in the two-layer structure composed of the die holder and the holder base, the die holder and the holder base being integrated by the clamper. The lower metal mold can be mounted or dismounted after the clamper for clamping the die holder and the holder base together is disengaged by an operation from the outside of the lower turret to separate the die holder from the holder base, and the die holder is taken out of the lower turret. However, in the above structure, some skills are required to enhance the precision of assembling the die holder and the holder base. The above structure still takes a lot of labor and time in mounting or dismounting or exchanging the lower metal mold. This point in dispute is the same with the punch press having a structure that allows two or more upper and lower metal molds to be selectively used, in addition to the turret type.

### SUMMARY OF THE INVENTION

The present invention has been achieved to solve the above-mentioned problems, and it is an object of the invention to provide a punch press which allows a lower metal mold on a lower turret to be mounted or dismounted or exchanged easily, in which a mounting structure for the lower metal molds is simplified.

In order to accomplish the above object, the present invention provides a punch press comprising an upper metal mold mounting board mounting the upper metal molds and a lower metal mold mounting board mounting the lower metal molds, in which a notch portion or bore for exchange of a lower metal mold is provided in the upper metal mold mounting board, and when the lower metal mold is mounted or dismounted, the notch portion or bore provided in the upper metal mold mounting board is positioned above the lower metal mold to be exchanged or its mounting hole, thereby mounting or dismounting the lower metal mold through the notch portion or bore. Also, the invention provides a punch press with the above constitution applied to the turret punch press, wherein an upper turret and a lower turret are formed rotatably independently of each other, with a notch portion or bore provided at a location corresponding to at least one metal mold of the lower turret on the circumference of the upper turret, and when mounting or dismounting or exchanging the lower metal mold, the notch portion or bore is positioned above the lower metal mold or its mounting hole of the lower turret to be mounted or dismounted or exchanged.

In this invention, to allow the upper turret and the lower turret to be rotated independently of each other, a rotation driving source such as a motor may be provided for each of the upper and lower turrets, or a common driving source may be provided to rotate the upper and lower turrets, in which a clutch is interposed in the transmission system linking the upper and lower turrets to the common driving source, and let in or out to rotate the upper and lower turrets independently of each other.

### BRIEF DESCRIPTION OF THE DRAWINGS

FIG. 1 is a front view showing the essence of a drive system for the upper and lower turrets in a turret punch press according to the present invention.

FIG. 2 is a plan view schematically showing the drive system of FIG. 1.

FIG. 3 is an enlarged side cross-sectional view for explaining a situation in which a lower metal mold in a lower turret is mounted or dismounted (or exchanged) according to the invention.

FIG. 4 is a plan view showing one example of an upper turret according to the invention.

FIG. 5 is a plan view showing one example of a lower turret that is paired with the upper turret of FIG. 4.

FIG. 6 is a side view exemplifying the essence of the drive system for the upper and lower turrets in the well-known turret punch press.

FIG. 7 is a side cross-sectional view for explaining a situation in which the lower metal mold in the lower turret of FIG. 6 is mounted or dismounted (or exchanged).

FIG. 8 is a view showing the turret punch press equipped with the clutches on the output shaft of the motor.

### DETAILED DESCRIPTION OF THE PRESENT INVENTION

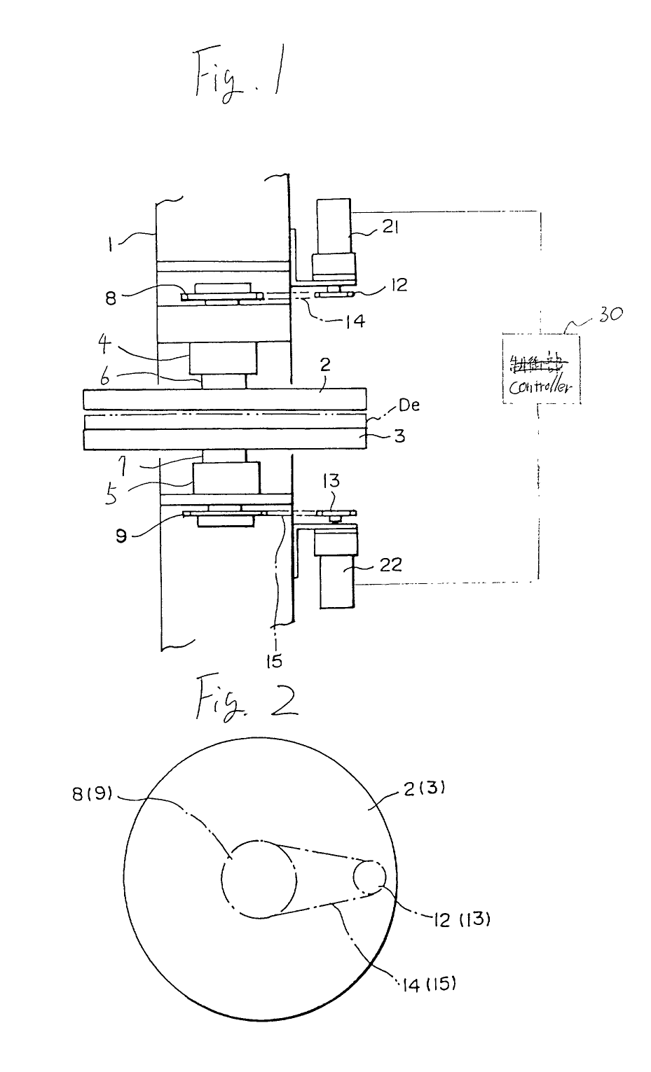

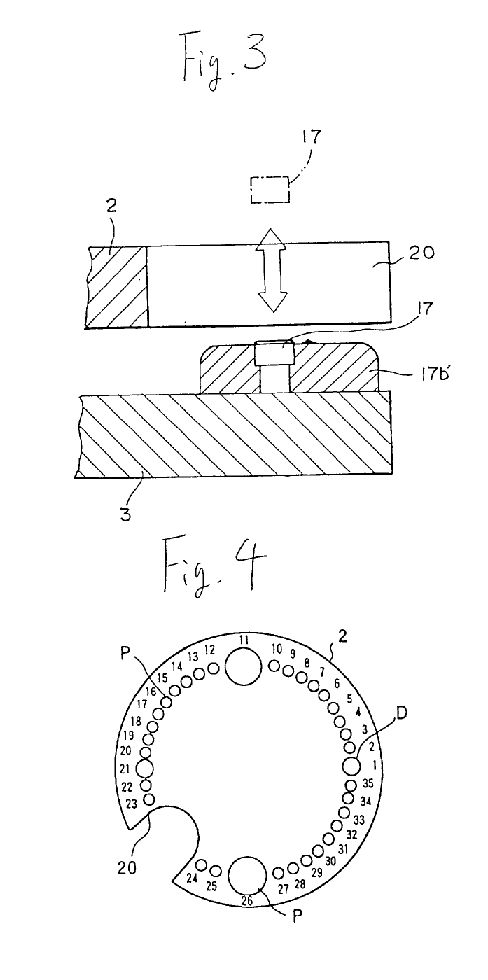

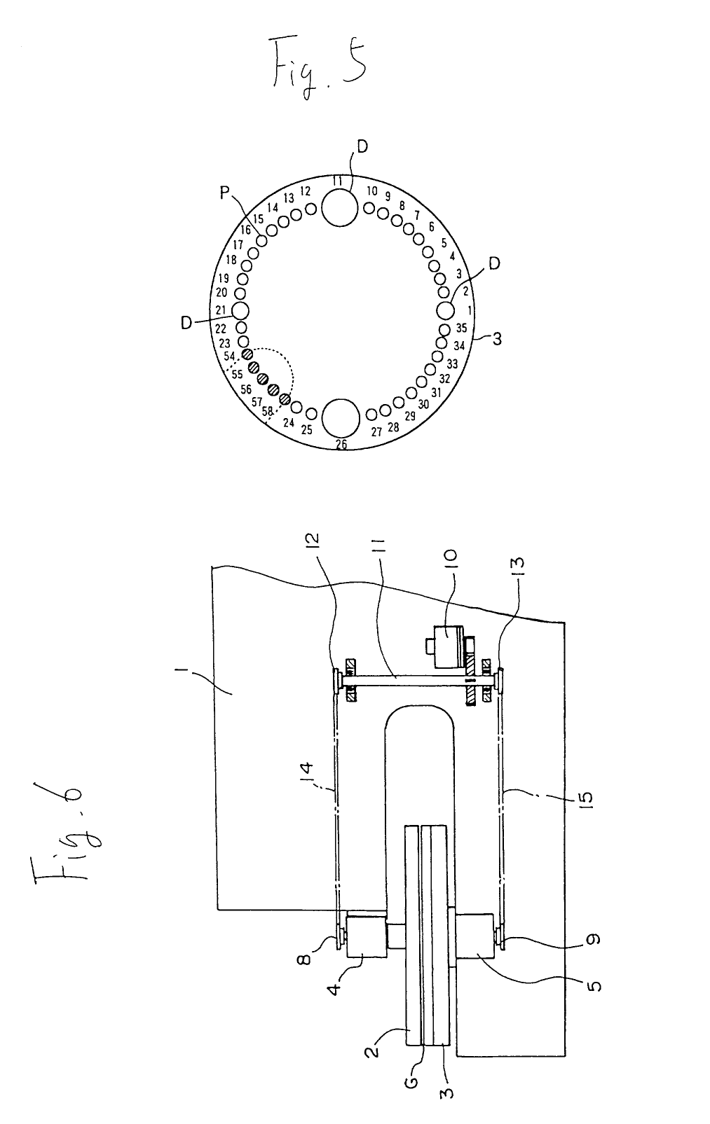

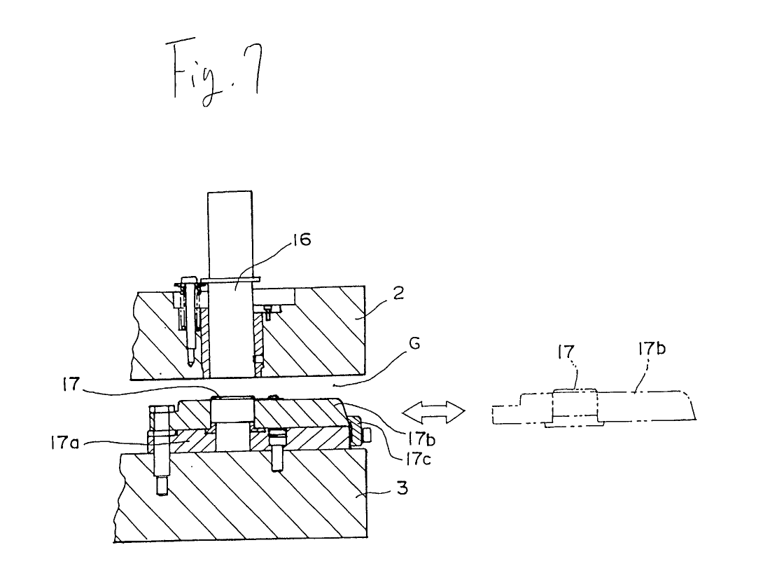

The preferred embodiments of the present invention will be described below with reference to the accompanying drawings. FIG. 1 is a front view showing the essence of a drive system for the upper and lower turrets in a turret punch press according to the invention. FIG. 2 is a plan view showing schematically the drive system of FIG. 1. FIG. 3 is an enlarged side cross-sectional view for explaining a situation of mounting or dismounting (exchanging) a lower metal mold for a lower turret according to the invention. FIG. 4 is a plan view showing an upper turret according to the invention. FIG. 5 is a plan view showing the lower turret that is paired with the upper turret of FIG. 4.

In the invention, a notch portion 2O (or bore) for mounting or dismounting the lower metal mold 17 is provided at a desired portion of the upper turret 2, and the lower metal mold 17 is directly dismounted through the notch portion 20 (or bore) of the upper turret 2 without removing the die holder 17b from the lower turret 3, as shown in FIG. 3. The characteristic constitution of this invention will be detailed with reference to FIGS. 1 to 5.

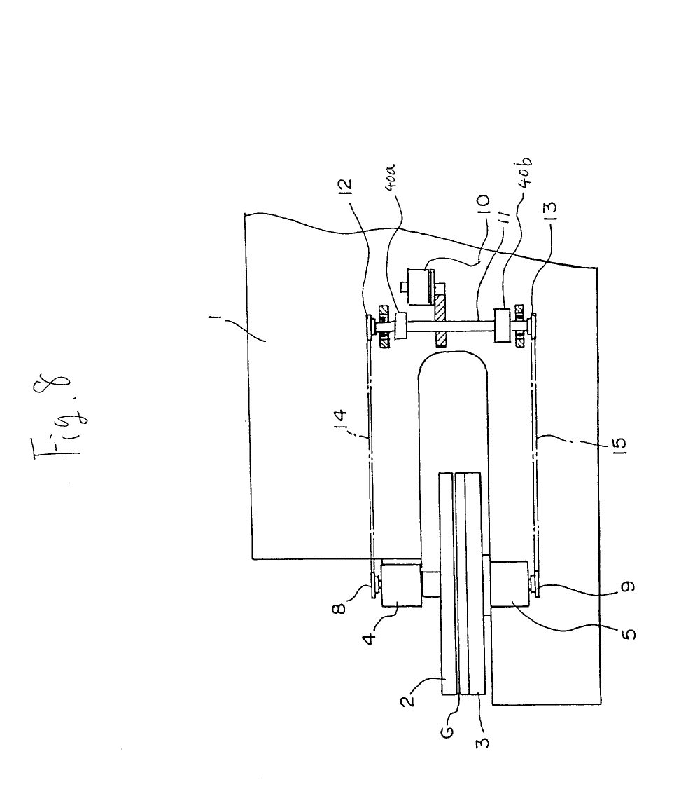

FIGS. 1 and 2 are a front view and a plan view showing one example of the turret punch press according to the invention. In FIGS. 1 to 5, the same or like parts are indicated by the same numerals as in FIGS. 6 and 7 for the conventional art.

FIG. 1 shows a drive system for driving the upper and lower turrets 2 and 3 according to one embodiment of the invention. The upper and lower turrets 2 and 3 are attached to the rotational shafts 6 and 7, respectively. The rotational shafts 6 and 7 are supported for free rotation by the ball bearings 4 and 5 attached to the frame 1. The outputs of the first and second motors 21 and 22 are transmitted from the chain pulleys 12 and 13 via the chains 14 and 15 to the chain pulleys 8 and 9, respectively. The rotational shafts 6 and 7 are connected to the chain pulleys 8 and 9, respectively, and the rotation of the chain pullets 8 and 9 forces the upper and lower turrets 2 and 3 to be rotated via the rotational shafts 6 and 7, respectively. A first motor 21 and a second motor 22 drive the upper turret 2 and the lower turret 3, respectively.

The upper and lower turrets 2 and 3 are rotated independently under control by the drive motors 21 and 22. In the normal punching, a control unit 30 controls a synchronous operation of the motors 21 and 22, such that the upper and lower turrets 2 and 3 can be operated in the same manner as the upper and lower turrets 2 and 3 for the well-known turret punch press of FIG. 6. In FIG. 1, reference sign De typically denotes a group of lower metal molds disposed on the upper face of the lower turret 3.

In the turret punch press as shown in FIGS. 1 and 2, a notch portion 20 is provided at at least one location on the outer circumference of the upper turret 2, or two or more locations in some cases, as shown in FIGS. 3 and 4. This notch portion 20 has an almost U-character shape with an open side leading to an outer circumferential face of the upper turret 2. In this invention, this notch portion 20 may be formed as a circular or rectangular shape, instead of the U-character shape. This notch portion 20 or bore is used for exchanging or dismounting or mounting the lower metal mold 17 of the lower turret 3. FIG. 4 is a plan view showing a specific example of the upper turret 2 according to the invention, and FIG. 5 is a plan view showing a specific example of the lower turret 3 that is paired with the upper turret of FIG. 4. In FIG. 4, P denotes one of a number of upper metal molds mounted on the upper turret 2, and the reference numeral drawn on the outer circumference of the upper turret 2 indicates the upper metal mold number. In FIG. 5, D denotes one of a number of lower metal molds mounted on the lower turret 3, and the reference numeral drawn on the outer circumference of the lower turret 3 indicates the lower metal mold number. In the lower turret 3, a portion corresponding to the notch portion 20 of the upper turret 2 is formed with a mounting portion for additional lower metal mold.

In this invention, the lower metal mold 17 can be simply mounted on the lower turret 3, because the notch portion 20 for mounting or dismounting the lower metal mold 17 is provided on the outer circumference of the upper turret 2. Since the lower metal mold 17 for the well-known turret punch press can not be mounted or dismounted in a narrow gap G between the upper and lower turrets 2 and 3, the die holder 17b is laid securely on the holder base 17a , and once removed from the holder base 17a to take it out of the turret 3, and the lower metal mold 17 is mounted or dismounted or exchanged. However, in this invention, the lower metal mold 17 can be directly mounted or dismounted through the notch portion 20 of the upper turret 2, whereby there is no need for the two stage fixture in which the die holder 17b is laid securely on the holder base 17a as conventionally.

The lower metal mold 17 of the invention a die holder 17b′ in which the holder base 17a and the die holder 17b are integrated as conventionally can be provided directly under the lower turret 3. In the case where the invention is applied to the well-known turret punch press of FIG. 4, as one example, the clutches 40a and 40b may be provided on the shared output shaft 11 between the output chain pulleys 12 and 13 for the upper and lower turrets, and let in or out (on-off control) to rotate the upper and lower turrets 2 and 3 individually, as shown in FIG. 8. However, in this case, the upper and lower turrets 2 and 3 cannot be simultaneously rotated at different start timings to make the positioning of the notch portion 20, or the lower metal mold. Note that in the structure of FIG. 1, the upper and lower turrets 2 and 3 can be controlled to be simultaneously rotated at different start timings.

An operation example in exchanging the lower metal mold on the lower turret 3 in the turret punch press of the invention that is constituted in the above way.

First of all, when the metal mold is exchanged, the punch press is set up in a metal mold exchange mode. Then, the lower metal mold number is designated, so that the lower turret 3 is rotated under control by the motor 22 to place the designated lower metal mold at the metal mold exchange position. And the upper turret 2 is rotated under control by the motor 21 to place the notch portion 20 of the upper turret 2 at the metal mold exchange position. This state is shown in FIG. 3, in which the lower metal mold 17 to be exchanged can be accessed directly through the notch portion 20 of the upper turret 2, and thereby can be exchanged easily and rapidly. The upper metal mold may be exchanged from the upper face side of the upper turret 2 in accordance with the conventional method.

In the above description, the invention is applied to the turret punch press, but may be also applied to a punch press of the type in which two or more pairs of upper and lower metal molds are provided, and selectively employed for working. In this case, a notch portion or bore for exchange of the lower metal mold may be provided in an upper metal mold mounting board (or an upper metal mold mounting plate) on which the upper metal molds are mounted, and in exchanging the lower metal mold, and the upper and lower metal mold mounting boards maybe relatively moved so that the notch portion or bore be positioned on the lower metal mold to be exchanged,

As described above, in the present invention, the mounting or dismounting operation for exchanging the lower metal mold can be conducted directly from the upper face of the lower metal mold through the notch portion or bore provided in the upper metal mold mounting board or upper turret, whereby there is no need for removing once the die holder from the die base and taking it outside the lower metal mold mounting board or lower turret as conventionally performed. In other words, the lower metal mold can be mounted or dismounted in the same access mode as the upper metal mold, whereby particularly the upper and lower metal molds in the turret punch press can be exchanged easily and rapidly.

Since the lower metal mold can be mounted or dismounted through the notch portion or bore provided in the upper turret, there is no need for the structure in which the die holder is laid on the die base, secured together by the clamper, and mounted on the lower turret, with some assembling precision. Accordingly, the lower metal mold can be mounted only using the die holder, whereby it takes less assemble time in mounting the lower metal mold with higher assembling precision.

Further, when the lower metal mold is automatically exchanged or mounted or dismounted, the upper and lower metal molds can be exchanged or mounted or dismounted in the same operation mode, whereby the metal mold can be automatically exchanged by a remarkably simple metal mold exchanging mechanism, and with its control content.

What is claimed is:

1. A method for removing a metal mold in a punch press
providing the punch press comprising a frame, an upper metal mold mounting board supported on the frame and mounting the upper metal molds, a lower metal mold mounting board supported on the frame and mounting the lower metal molds, the lower metal molds opposed to the upper metal molds, the upper metal mold mounting plate with an opening for exchange of a lower metal mold;
positioning the opening provided in the upper metal mold mounting board above the lower metal mold to be exchanged; and
removing the lower metal mold to be exchanged through the opening from the lower metal mold mounting board.

2. The method according to claim 1, wherein the positioning step includes:
moving at least one of the upper metal mold mounting board and the lower metal mold mounting board relative to the other; and
placing the opening to face one lower metal mold to be exchanged.

3. The method according to claim 1, wherein the opening is a notch portion provided in the upper metal mold mounting board.

4. The method according to claim 1, wherein the opening is a bore provided in the upper metal mold mounting board.

5. The method according to claim 1, wherein the lower metal mold is removed in a state where the upper metal mold mounting board and the lower metal mold mounting board are attached on the frame.

6. A method for mounting a metal mold in a punch press the method comprising:
providing the punch press comprising a frame, an upper metal mold mounting board supported on the frame and mounting the upper metal molds, a lower metal mold mounting board supported on the frame and mounting the lower metal molds, the lower metal molds opposed to the upper metal molds, the upper metal mold mounting board with an opening for exchange of a lower metal mold;
positioning the opening provided in the upper metal mold mounting board above a mounting hole of the lower metal mold mounting board through which the lower metal mold is mounted;
mounting the lower metal mold through the opening on the lower metal mold mounting board.

7. The method according to claim 6, wherein the positioning step includes:
moving at least one of the upper metal mold mounting board and the lower metal mold mounting board relative to the other; and
placing the opening to face the mounting hole through which the lower metal mold is mounted.

8. The method according to claim 6, wherein the opening is a notch portion provided in the upper metal mold mounting board.

9. The method according to claim 6, wherein the opening is a bore provided in the upper metal mold mounting board.

10. The method according to claim 6, wherein the lower metal mold is mounted in a state where the upper metal mold mounting board and the lower metal mold mounting board are attached on the frame.

11. A punch press comprising:
a frame;
an upper metal mold mounting board rotatably supported on the frame and mounting the upper metal molds; and
a lower metal mold mounting board rotatably supported on the frame independently of the upper metal mold mounting board and mounting the lower metal molds, opposed to the upper metal molds;
wherein an opening for exchange of a lower metal mold is provided in the upper metal mold mounting board corresponding to at least one metal mold on the lower metal mold mounting board.

12. The punch press according to claim 11, wherein the lower metal mold is mounted on the lower metal mold mounting board through the opening provided in the upper metal mold mounting board in such a way that the opening is positioned at the mounting hole of the lower metal mold mounting board through which the lower metal mold is mounted.

13. The punch press according to claim 11, further comprising:
a first motor for driving the upper metal mold mounting board;
a second motor for driving the lower metal mold mounting board; and
a controller for controlling the driving of the first motor and the second motor independently of each other so that the upper metal mold mounting board and the lower metal mold mounting board may be rotated independently of each other.

14. The punch press according to claim 11, further comprising;
a motor
a shaft that is driven and rotated by the motor; and
a clutch for controlling transmission of the rotation of the shaft to the upper metal mold mounting board and the lower metal mold mounting board to rotate the upper metal mold mounting board and the lower metal mold mounting board independently of each other.
